(19) United States
(12) Patent Application Publication
(10) Pub. No.: US 2026/0037326 A1
(43) Pub. Date: Feb. 5, 2026

(54) CAPACITY MANAGEMENT AND RESOURCE ALLOCATION FOR COLOCATION DATACENTERS

(71) Applicant: Hitachi, Ltd., Tokyo (JP)

(72) Inventors: Neda ZARAYENEH, Santa Clara, CA (US); Ravigopal Vennelakanti, Santa Clara, CA (US); Malar Samy, Santa Clara, CA (US); Pegah Mavaie, Santa Clara, CA (US); Omanshu Thapliyal, Santa Clara, CA (US); Prasun Singh, San Jose, CA (US)

(21) Appl. No.: 18/790,859

(22) Filed: Jul. 31, 2024

(51) Int. Cl. G06F 9/50; H04L 67/1008

(52) U.S. Cl. CPC G06F 9/505; G06F 9/5044; H04L 67/1008

(57) ABSTRACT

Resource allocation and configuration of equipment in colocation data centers, including predicting hierarchical capacity demand for each of the tenants of the colocation data centers using internal demand signals and external demand signals; determining remaining capacity available for the each of the tenants; determining additional capacity needed for the each of the tenants based on the remaining capacity available and the predicted hierarchical capacity demand of the each of the tenants; generating a recommended configuration for the each of the tenants determined to require additional capacity based on a current configuration of the each of the tenants and the determined additional capacity needed; for the recommended configuration being accepted, while the recommended configuration is being implemented, optimize allocation of resources to the recommended configuration based on tenant priority score function, current allocation, and remaining capacity; and controlling the colocation data centers to allocate the resources according to the optimization.

### BACKGROUND

### Field

The present disclosure is generally directed to datacenters, and more specifically, to resource allocation and management systems for colocation datacenters.

### Related Art

A colocation datacenter is a popular business model in which a datacenter operator provides space for third-party computing and networking equipment. In this arrangement, tenants rent additional services such as power, cooling, and communication from the datacenter operator. They share the facility with other tenants (enterprise tenants) or they acquire the whole building (hyperscalers).

With respect to capacity management and resource allocation of colocation data centers, the related art implementations involve a manual approach with little to no automation, regardless of industry.

Due to the digital transformation, colocation datacenters have encountered several challenges in the related art. One such challenge is encountering capacity constraints. The demand for data storage and processing has exceeded the current infrastructure capabilities of may colocation data centers. There is an urgent need for scalable solutions to accommodate rapid growth in demand.

Another such challenge involves supply chain disruptions. Supply chain backups can stall the growth of an industry. Delays in critical equipment delivery can impede growth and violate service level agreements (SLA). Long lead times can cost new deals for colocation datacenter vendors.

In the related art there is also a lack of a robust long-term demand forecasting model, which causes difficulty in determining the timing for adding capacity or constructing new facilities.

With respect to the operation of colocation datacenters, the current processes for allocating resources lack automation as well as visibility into inhouse resources. Such issues lead to inefficiencies in meeting the demand effectively and on time.

### SUMMARY

There are several problems regarding the optimal resource allocation in colocation datacenters. Data Center Infrastructure Management (DCIM) is used to monitor, manage and control all aspects of a data center infrastructure, such as power and cooling, Information Technology (IT) assets, space utilization, network connectivity, and so on. They can also help data center managers to make decisions and manage their facilities.

However, predicting the required resources, the time for ordering the resources, and allocating the resources needs a lot of consideration which is not currently automated in the current colocation datacenters and causes a long lead time to fulfill the orders and onboard new tenants.

Example implementations address the above problem by building a framework on top of the DCIM software to input the data from DCIM, the historical tenant usage, and some exogenous data to predict the usage, match the user specification to usage, preorder resources, and optimal (re) allocation of the resources to minimize the lead time for order fulfillment/tenant onboarding and maximize revenue.

In particular, the problem can be viewed as a capacitated resource allocation problem in which resources are a set of infrastructures that dynamically get produced and takes various amounts of time to prepare. The resources are assigned to a set of tenants based on the dynamic set of demands. Each facility has an installed capacity that will get reduced over time by assigning demands to consume the capacity. Example implementations formulate the problem in the form of an optimization problem in order to find the optimal allocation of resources to satisfy tenants' needs in minimal time while considering the priority score of tenants and available resources at each point of time.

This problem consists of five phases.

The first phase is the forecasting of the dynamic demand of tenants and facilities. The goal is to develop a resilient demand forecasting model that considers the ever-changing nature of tenant behavior and accounts for its fluctuations and uncertainties by considering both historical data, internal demand signals such as tenant characteristics and facility characteristics, and external demands signals including market trends, social media sentiment, and economic indicators. The example implementations formulate the problem as a multivariate timeseries forecasting problem. For the forecasting, example implementations conduct hierarchical forecasting which can involve forecasting per rack level, tenant level, and facility level. In this way, datacenters can have more clear idea of the tenant behavior and their usage to provision their future needs and notify them when they might need an expansion.

The second phase involves SLA automation, which can involve extracting and mining text data from SLA contracts to identify tenant importance and key deadlines. Additionally, example implementations can conduct risk assessment to send notifications for SLA violations, such as overuse or underuse of capacity.

The third phase involves the tenant priority score, which is provided by a dynamic priority score generator for tenants. The score generator is based on tenant importance extracted from SLA, power usage pattern, tenant characteristics, tenant region, and so on.

The fourth phase involves the configuration recommendation, which involves building a recommendation system to recommend the specification for the required resources to order for each tenant within a facility by considering the remaining capacity of facility and predicted demand. This phase provides a list of recommended configurations based on having the current configuration of the tenants, variations of the resources from procurement, and the score of each possible configuration.

The fifth phase is the order placement. Based on the recommended list of equipment and corresponding specification, the order gets placed by the system, sends notifications whenever the orders are ready, and provides the quantity of each available item.

Example implementations also optimize the allocation of dynamically produced infrastructures to tenant demands by taking into account the tenant priority score. In this context, optimal allocation refers to minimizing the lead time for order satisfaction.

Example implementations also involve an automated deal to resource allocation workflow, which involves the process of acquiring resources for predicted demand and efficiently assigning these resources as they become available. The goal is to prioritize tenants with the highest priority, ultimately reducing the lead time for allocation.

Aspects of the present disclosure can include a method for resource allocation and configuration of equipment for tenants of colocation data centers, which can involve predicting hierarchical capacity demand for each of the tenants of the colocation data centers using internal demand signals and external demand signals; determining remaining capacity available for the each of the tenants; determining additional capacity needed for the each of the tenants based on the remaining capacity available and the predicted hierarchical capacity demand of the each of the tenants; generating a recommended configuration of the equipment for the each of the tenants determined to require additional capacity based on a current configuration of the each of the tenants and the determined additional capacity needed; and for the recommended configuration of the equipment being accepted, while the recommended configuration is being implemented, optimize allocation of resources to the recommended configuration based on tenant priority score function, current allocation, and remaining capacity; and controlling the colocation data centers to allocate the resources according to the optimization.

Aspects of the present disclosure can include a computer program storing instructions for resource allocation and configuration of equipment for tenants of colocation data centers, which can involve predicting hierarchical capacity demand for each of the tenants of the colocation data centers using internal demand signals and external demand signals; determining remaining capacity available for the each of the tenants; determining additional capacity needed for the each of the tenants based on the remaining capacity available and the predicted hierarchical capacity demand of the each of the tenants; generating a recommended configuration of the equipment for the each of the tenants determined to require additional capacity based on a current configuration of the each of the tenants and the determined additional capacity needed; and for the recommended configuration of the equipment being accepted, while the recommended configuration is being implemented, optimizing allocation of resources to the recommended configuration based on tenant priority score function, current allocation, and remaining capacity; and controlling the colocation data centers to allocate the resources according to the optimization. The computer program and instructions can be stored on a non-transitory computer readable medium and executed by one or more processors.

Aspects of the present disclosure can include a systems for resource allocation and configuration of equipment for tenants of colocation data centers, which can involve means for predicting hierarchical capacity demand for each of the tenants of the colocation data centers using internal demand signals and external demand signals; means for determining remaining capacity available for the each of the tenants; means for determining additional capacity needed for the each of the tenants based on the remaining capacity available and the predicted hierarchical capacity demand of the each of the tenants; means for generating a recommended configuration of the equipment for the each of the tenants determined to require additional capacity based on a current configuration of the each of the tenants and the determined additional capacity needed; and for the recommended configuration of the equipment being accepted, while the recommended configuration is being implemented, means for optimizing allocation of resources to the recommended configuration based on tenant priority score function, current allocation, and remaining capacity; and means for controlling the colocation data centers to allocate the resources according to the optimization.

Aspects of the present disclosure can include an apparatus for resource allocation and configuration of equipment for tenants of colocation data centers, which can involve a processor, configured to predict hierarchical capacity demand for each of the tenants of the colocation data centers using internal demand signals and external demand signals; determine remaining capacity available for the each of the tenants; determine additional capacity needed for the each of the tenants based on the remaining capacity available and the predicted hierarchical capacity demand of the each of the tenants; generate a recommended configuration of the equipment for the each of the tenants determined to require additional capacity based on a current configuration of the each of the tenants and the determined additional capacity needed; and for the recommended configuration of the equipment being accepted, while the recommended configuration is being implemented, optimize allocation of resources to the recommended configuration based on tenant priority score function, current allocation, and remaining capacity; and control the colocation data centers to allocate the resources according to the optimization.

### BRIEF DESCRIPTION OF THE DRAWINGS

FIG. 1 illustrates an overall system diagram upon which example implementations can be applied, in accordance with an example implementation.

FIG. 2 illustrates an example of an automated deal to resource allocation workflow, in accordance with an example implementation.

FIG. 3 illustrates a flow for the overall procedure, in accordance with an example implementation.

FIG. 4(a) illustrates an example output of the power forecast per tenant level, and how internal and external factors influence power usage, in accordance with an example implementation.

FIG. 4(b) illustrates an example process to assign resources to the tenants, in accordance with an example implementation.

FIG. 5 illustrates an example of the product matching and parts recommendation system, in accordance with an example implementation.

FIG. 6 illustrates an example of the output to allocate resources at a point in time based on the lead time and the service level agreement, in accordance with an example implementation.

FIG. 7 illustrates an example overview of the applications and information regarding input of each application, in accordance with an example implementation.

FIG. 8 illustrates example outputs of datacenter portfolio rationalization KPIs and KRIs, in accordance with an example implementation.

FIG. 9 illustrates an example of KPI/KRI drill down analysis, in accordance with an example implementation.

FIGS. 10(a) to 10(c) illustrate examples of attributes and input samples, in accordance with an example implementation.

FIG. 11 illustrates an example output for the equipment and the corresponding score for a sub part recommendation, in accordance with an example implementation.

FIGS. 12(a) and 12(b) illustrate examples of a vendor product list hierarchy, in accordance with an example implementation.

FIG. 13 illustrates an example of the tenant product list hierarchy, in accordance with an example implementation.

FIG. 14 illustrates an example of the vendor product list hierarchy, in accordance with an example implementation.

FIG. 15 illustrates an example output of the lead time for satisfying demands for each tenant demand, in accordance with an example implementation.

FIGS. 16(a) and 16(b) illustrate an example of the input for the dynamic resource allocation application, in accordance with an example implementation.

FIG. 17 illustrates a plurality of tenants that are networked to a management apparatus in a colocation data center, in accordance with an example implementation.

FIG. 18 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

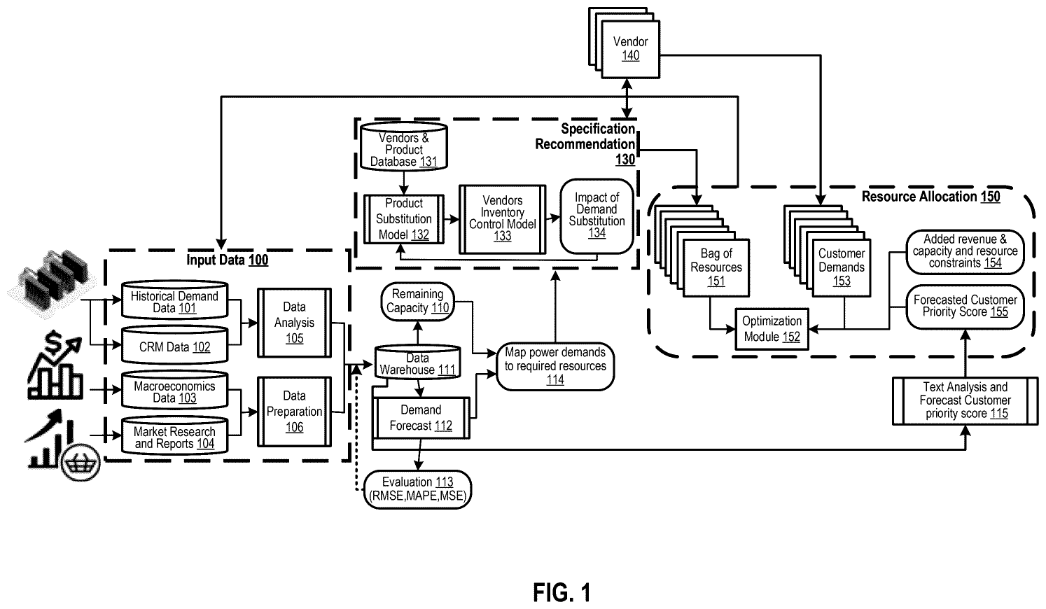

FIG. 1 illustrates an overall system diagram upon which example implementations can be applied, in accordance with an example implementation. In example implementations herein, there are three aspects, the data input system 100 for analysis, the specification recommendation system 130 and the resource application system 150. The types of data that can be input into the data input system 100 can include, but is not limited to, historical demand data 101, tenant relationship management (CRM) data 102, Macroeconomics data 103, and Market Research and Reports data 104. Historical demand data 101 and CRM data 102 can be processed for data analysis 105. Macroeconomics Data 103 and Market Research and Reports 104 can go through pre-processing via data preparation 106. The output of the data analysis 105 and the data preparation 106 can be stored in a data warehouse 111 such as a database system as is known in the art.

Based on the data in the data warehouse 111, various aspects can be derived. For example, the remaining capacity 110 of the data center can be derived. Further, a process to forecast the demand 112 can be executed to produce an output of the expected demand 113. The remaining capacity 110 and the expected demand 113 can then be utilized to map the power demands to the required resources 114. The data warehouse 111 can also be used to forecast the tenant priority score through a process to conduct text analysis 115.

Example implementations further involve a specification recommendation system 130 that will generate a recommended equipment configuration for the tenant in the colocation data centers. Specification recommendation system 130 can manage a vendors and product database 131 as well as receive an input regarding a vendor 140 for the tenant and the map of the power demands to the required resources 114. The specification recommendation system 130 will iteratively execute a product substitution model 132 and a vendors inventory control model 133 to determine the impact of a demand substitution.

Example implementations further involve a resource allocation system 150 that will control the colocation data center to allocate the resources. The resource allocation system 150 can include a bag of resources 151, the tenant demands 153, the forecasted tenant priority score 15 and the added revenue, capacity and resource constraints 154, which are then processed by an optimization module 152 to generate the resource allocation.

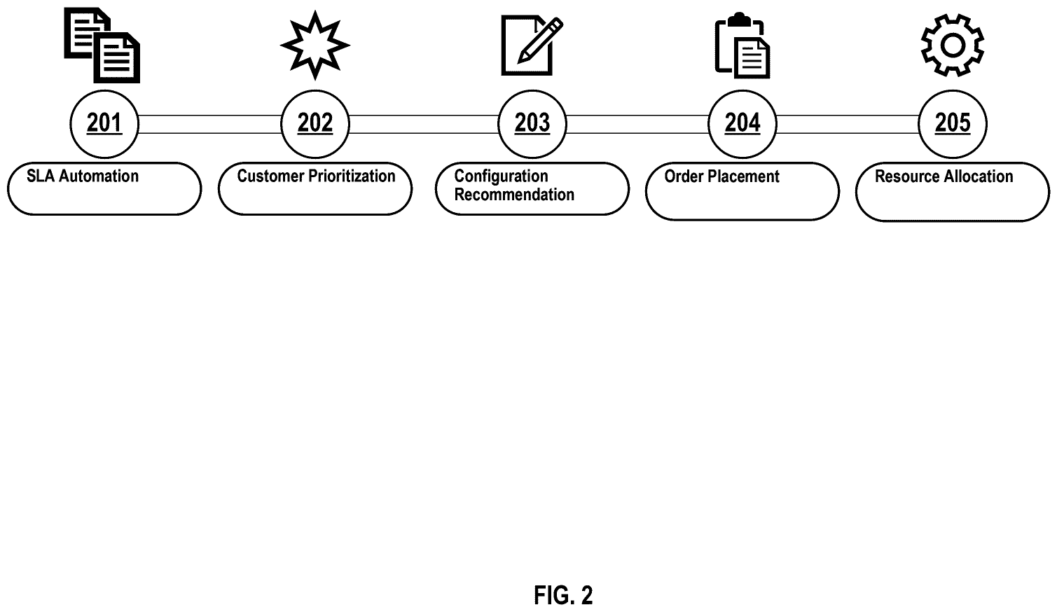

FIG. 2 illustrates an example of an automated deal to resource allocation workflow, in accordance with an example implementation.

Example implementations also involve an automated deal to resource allocation workflow, which involves the process of acquiring resources for predicted demand and efficiently assigning these resources as they become available. The goal is to prioritize tenants with the highest priority, ultimately reducing the lead time for allocation.

In the first part of the workflow, there is Service Level Agreement (SLA) automation 201 in which the SLA for the tenant is processed to determine the tenant's priority based on the importance of the tenant, the priority of the process to be utilized and the deadline specified by the SLA. These are processed by tenant prioritization 202 to determine the overall tenant priority for the colocation data center. The tenant prioritization 202 can also conduct a risk assessment to determine the risk of violating the SLA based on the power usage pattern, tenant characteristics and tenant region, and generate a notification to the data center manager regarding an impending SLA violation.

Based on the tenant prioritization 202, a configuration recommendation 203 is generated. The configuration recommendation 203 can involve a list of recommended equipment configurations and includes the current tenant configuration, variations of the tenant configuration based on the available resources, and a score for each of the configurations. Once a configuration is selected, an order placement is executed at 204 to gather the final recommended list of resources of the colocation data center, execute an order for the required resources and provide quantities of the available resources over time. Once the provided quantities of resources are made available, the resources allocation 205 predicts the upcoming demand, determines the SLA lead time and the available resources, and executes an optimization algorithm to allocate the resources and output the order fulfillment time.

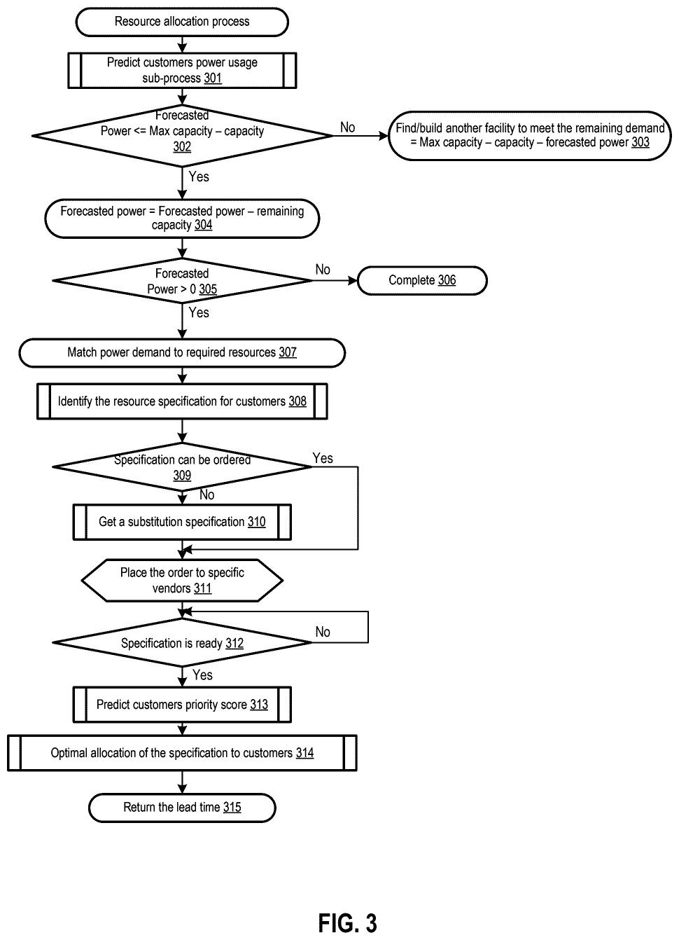

FIG. 3 illustrates a flow for the overall procedure, in accordance with an example implementation. At first, a sub-process is executed at 301 to predict the power usage of the tenants. At 302, a determination is made if the forecasted power is less than or equal to the remaining capacity (e.g., the difference between the maximum capacity and the capacity being used). If not (No), the data center does not have sufficient capacity to handle the proposed resource allocation, and a different data center having sufficient capacity is selected at 303.

Otherwise (Yes), the process proceeds to 304 to reduce the forecasted power by the remaining capacity. At 305, a determination is made as to whether the updated forecasted power consumption is greater than zero. If not (No), then there is sufficient remaining capacity to conduct the resource allocation, and the resource allocation is executed and completed at 306. Otherwise (Yes), the flow proceeds to 307 to match the power demand to the required resources. At 308, a list of resource specifications is identified for the proposed tenants to determine if resource allocation can be changed. At 309, a determination is made as to whether a specification from the list can be ordered. If not (No), then the flow proceeds to 310 to select another specification from the list. Otherwise (Yes), the flow proceeds to 311 to place the order to specific vendors for the specified equipment.

At 312, once the specification is ready (Yes), the flow proceeds to 313 to predict the tenant's priority score, and then to 314 to execute an optimized allocation of the specification to the tenants. At 315, the lead time of the allocation is then returned.

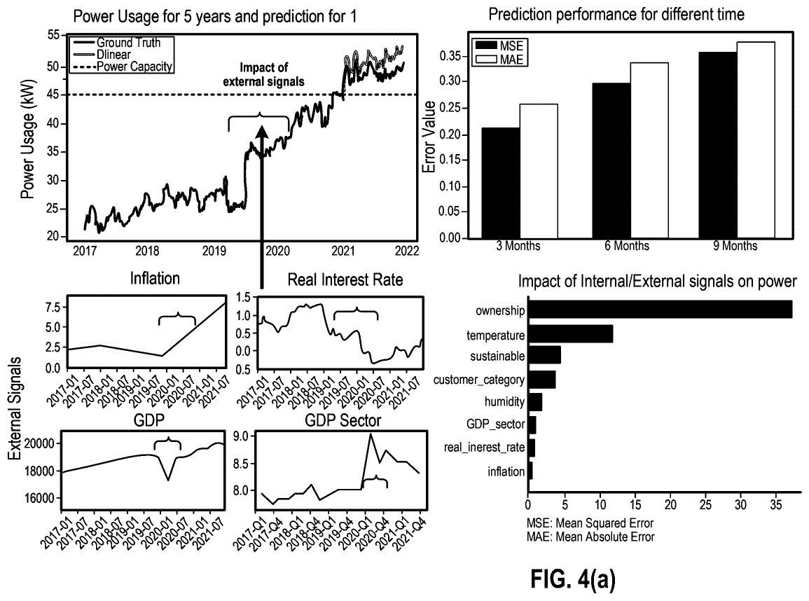

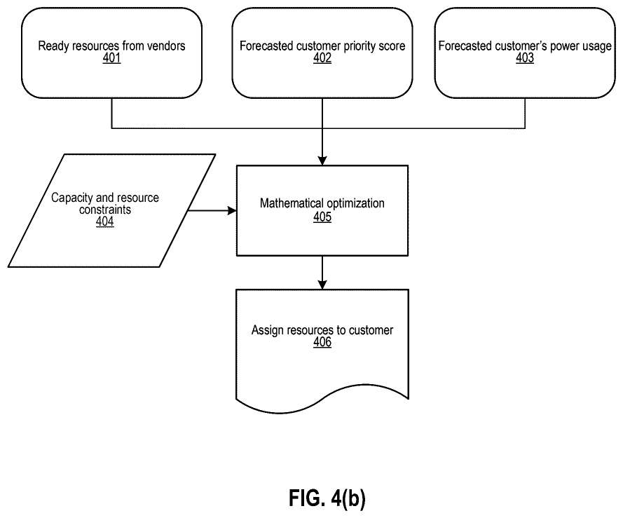

FIG. 4(a) illustrates an example output of the power forecast per tenant level, and how internal and external factors influence power usage, in accordance with an example implementation. As shown in FIG. 4(a), power usage can be affected by external signals such as macroeconomic data (e.g., inflation, real interest rate, gross domestic product, etc.), and internal signals such as ownership, temperature, and so on. As shown, the problem is to model the total demand for the colocation data center through searching for the internal and external factors that affect resource demand. Based on the result, a survival prediction (e.g., time to capacity depletion) can be conducted as well as optimized scheduling based on the time needed for resource orders so as to prevent long wait times.

FIG. 4(b) illustrates an example process to assign resources to the tenants, in accordance with an example implementation. Example implementations can conduct mathematical optimization 405 based on the capacity and resource constraints 404, the ready resources from vendors 401, the forecasted tenant priority score 402, and the forecasted tenant's power usage 403. The optimization produces an allocation that can be used to assign resources to the tenant at 406.

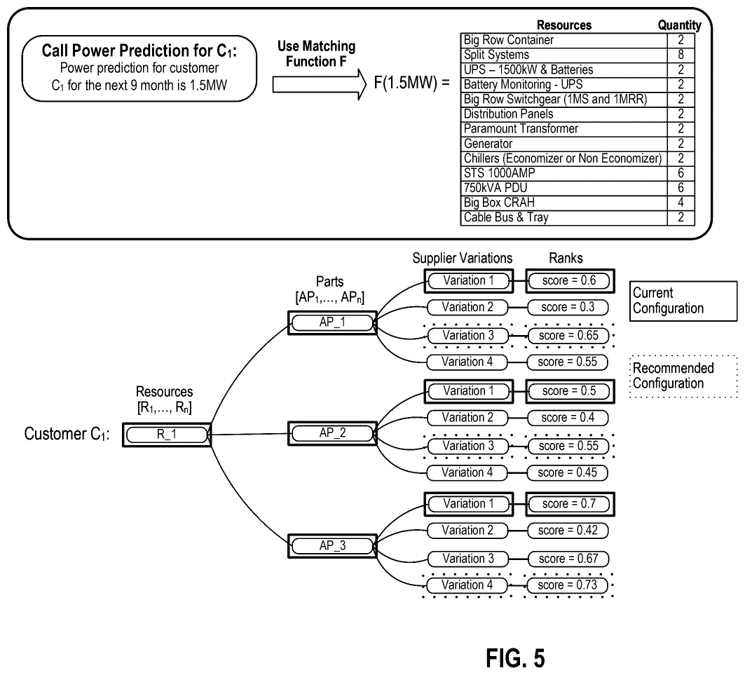

FIG. 5 illustrates an example of the product matching and parts recommendation system, in accordance with an example implementation. The product matching involves matching the predicted power to the list of the required resources, and determines a quantity that is needed for each resource as shown at the top part of FIG. 5. For the recommendation system, the top n configurations are listed based on a score that can include, but is not limited to, wait time, quality/sustainability, warranty, and SLA requirements.

In the example implementation of FIG. 5, the current configuration of tenant C1 is as follows.

$$( {R}_{1 ,} , {R}_{2} , … , {R}_{n} ) = ( [ {AP}_{11} , {AP}_{12} , … , {AP}_{1 {m}_{1}} ] , ( [ {AP}_{21} , {AP}_{22} , … , A {P}_{2 {m}_{2}} ] , … , [ A {P}_{n 1} , A {P}_{n 2} , … , {AP}_{n {m}_{n}} ] ) Corresponding score for each part = ( [ {S}_{11} {S}_{12} , … , {S}_{1 {m}_{1}} ] , [ {S}_{21} {S}_{22} , … , {S}_{2 {m}_{2}} ] , [ {S}_{n 1} , {S}_{n 2} , … , {S}_{n {m}_{n}} ] )$$

Sₙₘ=0.5*availability+0.2*durability+0.2*warrenty+0.1*sustainability (availability, durability, warranty, sustainability are numbers between 0 and 1 defined for each part)

If Sₙₘ_{ⁱ} is the recommended part and Sₙₘ is the current score of the part then we choose the part that has the least difference with the Sₙₘ, means Sₙₘ_{ⁱ}−Sₙₘ is the least positive number.

$$S ( Overall score ) = \sqrt{\begin{matrix}\sqrt{( {S}_{11}^{2} + {S}_{12}^{2} + … + {S}_{1 {m}_{1}}^{2} ) +} \sqrt{( {S}_{21}^{2} + {S}_{22}^{2} + … + {S}_{2 {m}_{2}}^{2} ) +} \\ \sqrt{( {S}_{21}^{2} + {S}_{22}^{2} + … + {S}_{2 {m}_{2}}^{2} )}\end{matrix}}$$

$${i}^{th} Recommended configuration = ( {R}_{1}^{i} , {R}_{2}^{i} , … , {R}_{n}^{i} ) = ( [ A {P}_{11}^{i} , {AP}_{12}^{i} , … , {AP}_{1 {m}_{1}}^{i} ] , [ {AP}_{21}^{i} , A {P}_{22}^{i} , … , {AP}_{2 {m}_{2}}^{i} ] , … , [ {AP}_{n 1}^{i} , {AP}_{n 2}^{i} , … , {AP}_{n {m}_{n}}^{i} ] )$$

If Sᵢ is the i^{th} recommended config score then we select the one that has the least difference with the S, which means Sᵢ−S is the is the least positive number among all recommended configurations

In the previous example: 0.65-0.6 has the least positive number for the first part, 0.55-0.5 has the least positive number for the second part, and 0.73-0.7 has the least positive number for the third part

For the priority score determination, there can be different policies regarding how to serve the tenant. Here a score is assigned to each tenant that shows the priority of each tenant. There are several factors that are involved in this assignment.

The penalty cost can be obtained based on sentiment analysis. Further, the expected revenue of a business can be derived based on historical data. Other factors are fed to the predictive model to predict the priority score.

In example implementations, the predictive model to predict the priority of the score of the tenant intakes historical data such as, but not limited to, revenue, order value, penalty cost, and starting data. The output is a priority score for each tenant.

In the example implementations described herein, there is a problem selection and setting for a dynamic resource allocation optimization problem. The problem herein is to allocate a set of resources at time step t to meet tenant i's demand in the least possible time. Such a problem is a dynamic optimization/dynamic decision problem (discrete) as follows:

For finding the optimal set of resources at specific time t to meet tenant demand, each tenant has unique weight wᵢ (priority score). The optimization is the lead time objective by considering the tenant priority score and constraints.

The dynamic resource allocation optimization problem takes in as input, demand information (e.g., the dynamic set of demands at each time step), facility information (e.g., the capacity of each facility (used and remained) and their characteristics such as sustainable energy), and resource information (e.g., the availability and readiness of resources (infrastructures) at each time step).

For the sets, let T be the set of time steps, F be the set of facilities, R be the set of resources, D be the set of demands, and C be the set of tenants. Parameters can involve the following:
d_{r,c,f,t}: The demand of resource r for tenant c in facility f at time step t.
a_{r,t}: The available amount of resource r at time step t.
rc_{f,r}: The remained capacity of resource r at facility f.
M_{f,r}: Maximum capacity that facility f can host.
PriorityScore_{c,f,t}: The priority score of tenant c in facility f at time step t.

Decision Variables can involve the following:
x_{r,c,f,t}: integer value (needed number of resource r) if resource r assigned to tenant c in facility f at time step t, 0 otherwise.

The objective function is then outlined as follows:

$$( LeadTimeOptimize / QuickServe ) Minimize f = {\sum }_{c ∈ C} {\sum }_{t ∈ T} {\sum }_{f ∈ F} ( t - {t}_{s} ) * \frac{1}{{PriorityScore}_{c , f , t}} * ( 1 + {\sum }_{r ∈ R} {( {d}^{r , c , f , t} - {x}_{r , c , f , t} )}^{2} ) )$$

The output is to achieve the least lead time while satisfying tenant demands, wherein each tenant has a demand D corresponding to a list of resources R. The time is calculated when the demand is satisfied.

Constraints can include the following:

Facility Capacity Constraint: For each facility f, resource r, and time t, the demand assigned to the tenants for resource r should not exceed its capacity:

$${\sum }_{c ∈ C} {\sum }_{{{t}^{′}}^{= 1}}^{t} {x}_{f , c , r , {t}^{′}} \leq {M}_{f , r} - {C}_{f , r} ∀ f , ∀ r , ∀ t$$

Resource availability constraint: The allocated resources should respect the availability and readiness time of each resource:

$${\sum }_{f ∈ F} ( {\sum }_{c ∈ C} {x}_{f , c , r , t} - r {c}_{f , r} ) \leq {a}_{r , t} ∀ r ∈ R , ∀ t ∈ T$$

For each tenant c and resource r, there must be a time step when their demand is fulfilled:

$${\sum }_{{t}^{= 1}}^{T} {x}_{f , c , r , t} = {d}_{f , c , r , t} ∀ f ∈ F , ∀ c ∈ C , ∀ r ∈ R$$

Non-Negativity Constraint: Ensure the non-negativity of the decision variables:

$${x}_{f , c , r , t} \geq 0 ∀ f ∈ F , ∀ c ∈ C , ∀ r ∈ R , ∀ t ∈ T$$

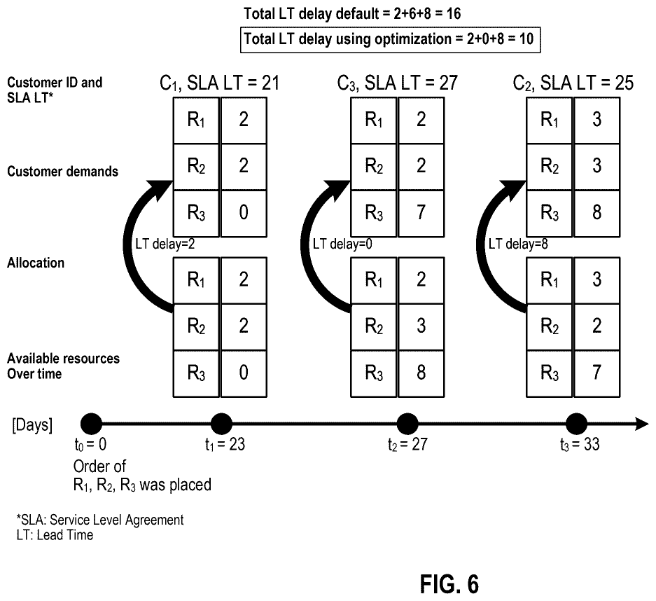

FIG. 6 illustrates an example of the output to allocate resources at a point in time based on the lead time and the service level agreement, in accordance with an example implementation. As shown in FIG. 6, the problem involves the hard allocation of the incoming available resources, which can include the management of the partial delivery of parts, factoring tenant priority, optimizing resource allocation to reduce lead time, and so on. As shown in the example allocation of FIG. 6, the total lead time delay through using the optimization described herein is shorter than the lead time delay without the optimization.

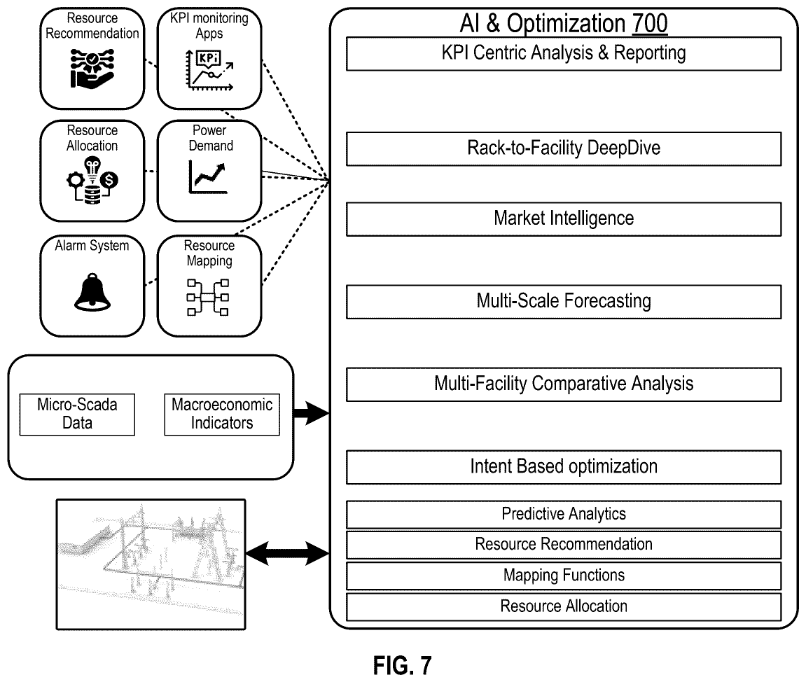

FIG. 7 illustrates an example overview of the applications and information regarding input of each application, in accordance with an example implementation. The example functions that can be facilitated in the AI and optimization 700 can include, but is not limited to, Key Performance Indicator (KPI) Centric analysis and reporting, rack-to-facility deep dives, market intelligence, multi-scale forecasting, multi-facility comparative analysis, and intent based optimization. Other functions can include predictive analytics, resource recommendations, managing functions, and resource allocations, which can be communicated to the underlying system. Examples of applications that can be facilitated by the AI and optimization 700 can include resource recommendation, KPI monitoring, resource allocation, power demand monitoring, alarm systems, and resource mapping.

In example implementations, the general input data can be from internal sources such as data center facility usage records, SLAs, power utilization and registered SLAs, as well as external sources such as industry wide market indicators, industry wide macro-economic trends and tenant similarity analysis.

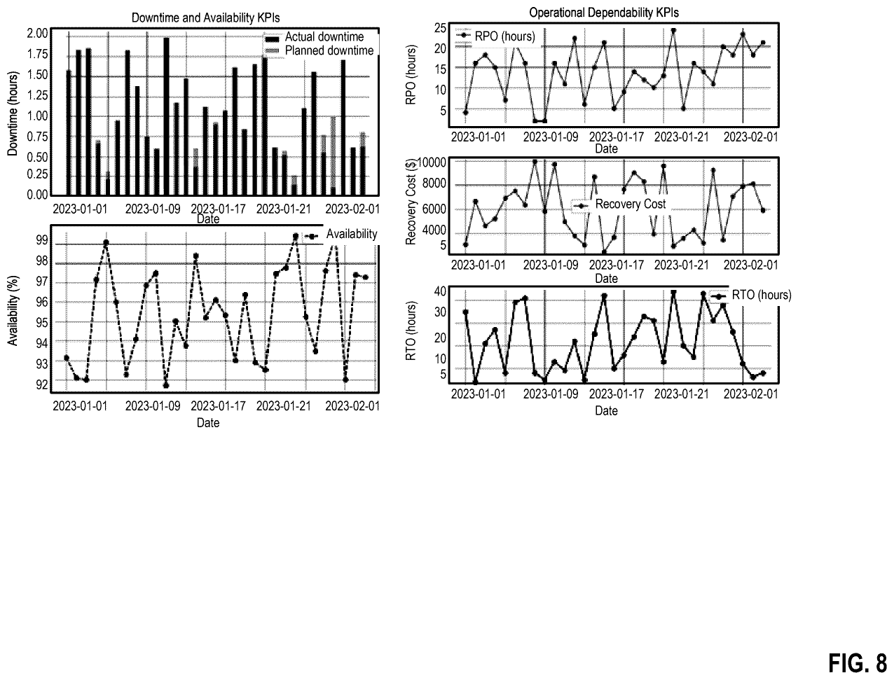

FIG. 8 illustrates example outputs of datacenter portfolio rationalization KPIs and KRIs, in accordance with an example implementation. Key Risk Indicators (KRIs) are chosen to give strategic and tactical capabilities, and can bring in an additional insight into the effect of external factors like extrema weather events, socio-economic threats, and so on. KRIs can be used for risk mitigation and action management, reporting and documentation, generation of alerts and notifications, data governance and quality control, collaboration and sharing, visualize scalability and performance, data retention and archiving, auditing and compliance, and so on.

In the example of KRIs that are assessed in FIG. 8, there can be downtime and availability, operational dependability, and so on in accordance with the desired implementation. Other examples of KRIs can include, but are not limited to natural disasters and geographical risks, network and connectivity issues, data center infrastructure aging, cybersecurity threats, energy efficiency and sustainability metrics, environmental monitoring, disaster preparedness and recovery, SLA adherence, capacity planning and scalability, operational efficiency and resource utilization, energy cost fluctuations, change management, and so on.

Similar to KRIs, there can also be outputs of datacenter portfolio rationalization KPIs, in accordance with a desired implementation. The KPIs can facilitate data collection/integration, customizable stakeholder specific insights, prioritization of metrics selection and visualization, alerts and notifications, drill down filtering and slicing, and comparative analysis. Examples of KPIs can include, but are not limited to, capacity survival, stranded/over consumption conditions, space utilization, revenue per rack, and so on.

Metrics are designed based on functional matrix with categorical axis ranging from capacity-to-sustainability and application axis ranging from power grid-to-server delivery.

Other examples of KPIs can include, but are not limited to client satisfaction and retention, tenant churn rate, space planning efficiency, physical security utilization, space turnover rate, rack fill rate, space forecast accuracy, renewable energy usage, occupancy rate, and so on.

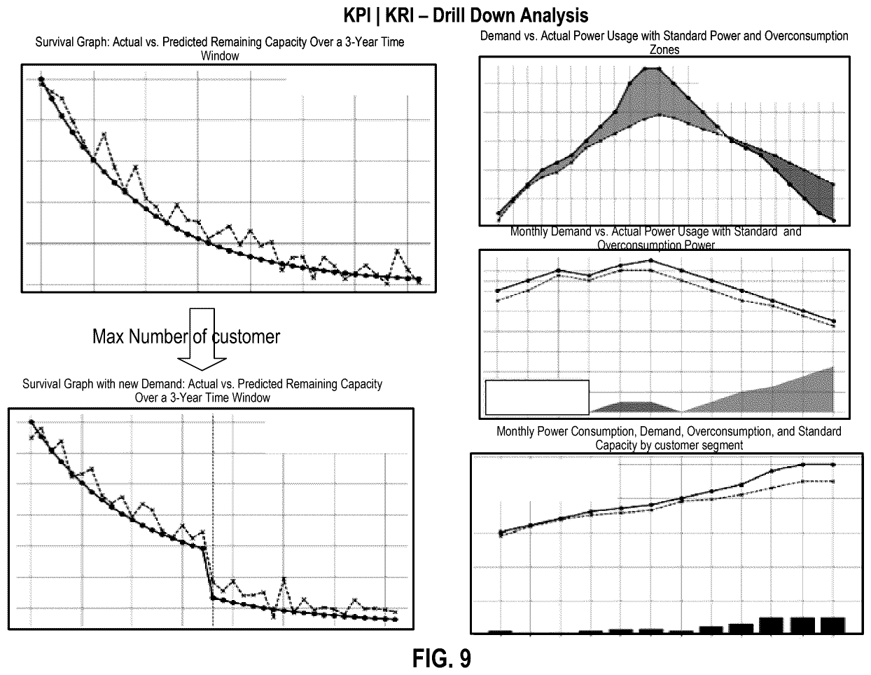

FIG. 9 illustrates an example of KPI/KRI drill down analysis, in accordance with an example implementation. In addition, there can also be KPI/KRI drill down analysis such as capacity survival analysis. Capacity survival analysis can involve a deep dive into remaining available capacity based on order and deal closure dates. The capacity survival analysis facilitates the estimation capacity and utility based with reference to actual and expected demand, and tenant/tenant segment based analysis on standard and overused. The utilization of capacity survival analysis can facilitate deal-based planning, identification capacity usage trends and similarity, as well as contextual understanding of tenant usage behavior.

Example implementations described herein can also facilitate a power capacity forecast. The power usage prediction and analytics will help to predict and analyze daily, weekly, monthly power consumption patterns by facility location for each tenant, detect overconsumption and stranded capacity units, as well as establish tenant similarity based on usage patterns.

In example implementations there can be an energy management application that takes in as input, power consumption data from all devices, cooling system metrics, tenant and facility contextual information, external weather and humidity data, and macroeconomic data. The output data can include energy usage reports, predictive analytics for future consumption, and suggestions for energy-saving measures.

This application can provide a short-term, mid-term and long-term power usage of racks/tenants/facilities considering both internal and external factors affecting the power usage. Such an example application can be constructed through any method as desired, such as machine learning.

Example of output can be the power prediction for three, six, and 12 months, in accordance with the desired implementation. For training a machine learning algorithm, the output can be tagged with a time stamp, the actual power consumption for the timestamp, and the predicted power consumption at the time stamp. In this manner, training data can be constructed to be fed back into a reinforcement learning algorithm to generate better predictions.

Example inputs regarding the tenants to the application from the data center can include, but are not limited to, power usage of tenant per hour (MW/KW), tenant ownership (leased/entire building), tenant category (Health, e-commerce, etc.), installed power capacity for the tenant, max power capacity to be installed for the tenant, number of (used/unused) racks per tenant, types of applications being run by the tenant (high-compute tasks, storage-heavy workloads) operational schedules of the tenant (schedules for batch processing or other intensive tasks), SLAs about power availability and uptime guarantees for the tenant, and so on. Example inputs for the facilities can include, but are not limited to, facility name/ID, facility state/city, temperature/humidity of facility per hour (if different per tenant area then it can be broken down to per tenant area), energy sources used (e.g., renewable/non-renewable), installed power capacity, max power capacity to be installed, capacity of uninterruptible power supplies (UPS) and generators, and so on.

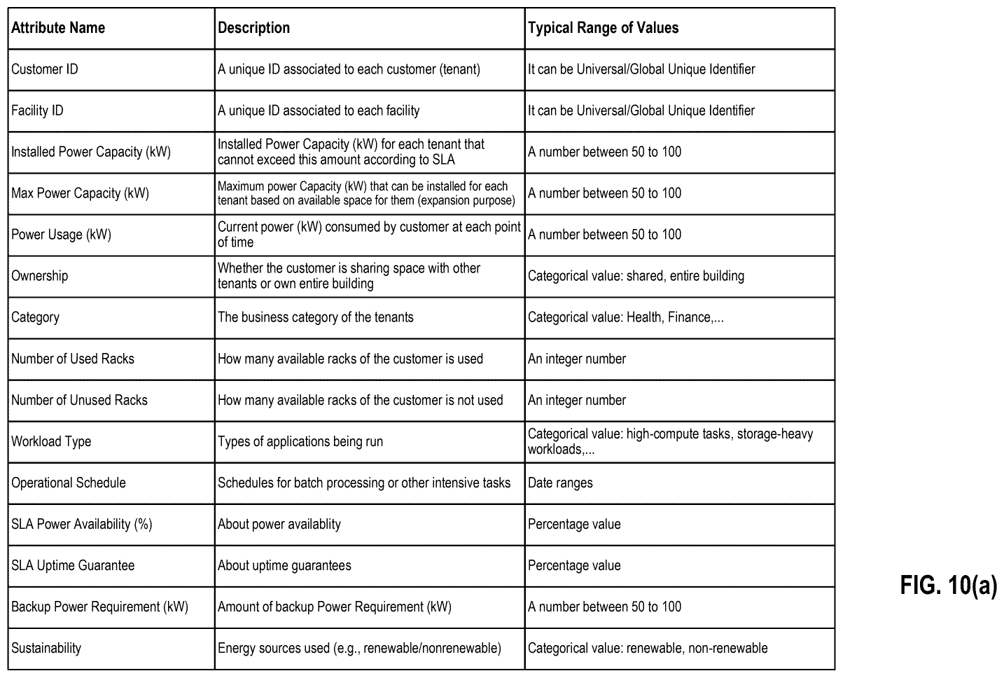

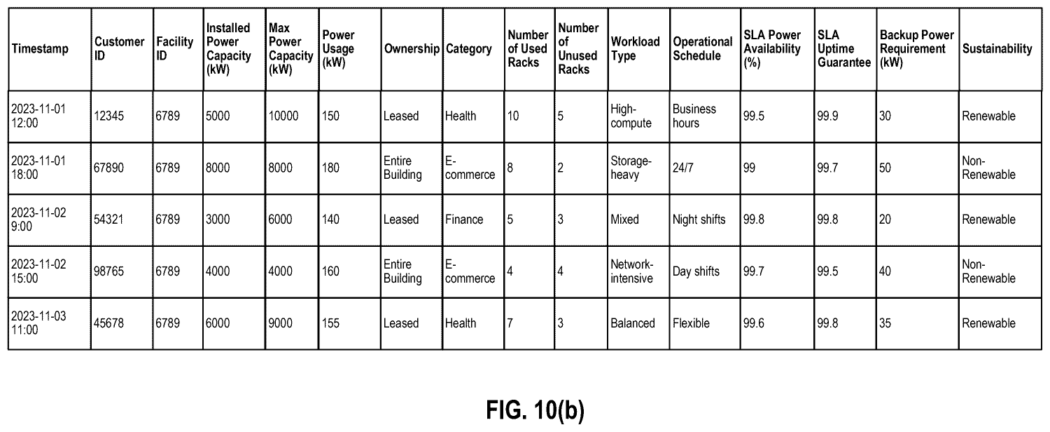

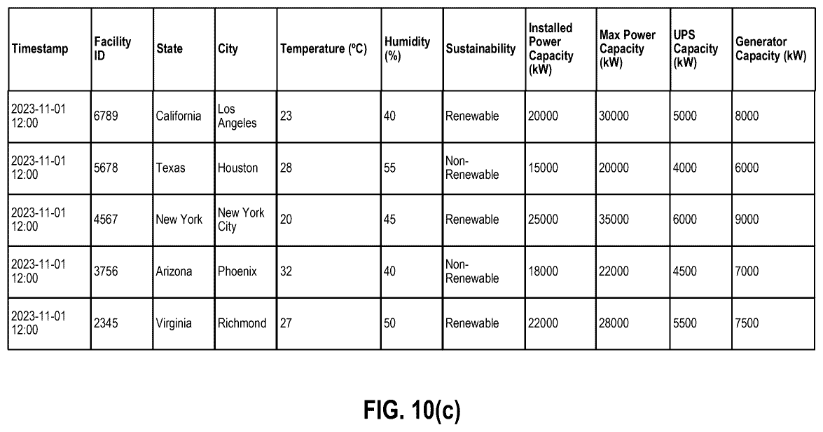

FIGS. 10(a) to 10(c) illustrate examples of attributes and input samples, in accordance with an example implementation. Specifically, FIG. 10(a) illustrates examples of attributes along with their descriptions, FIG. 10(b) illustrates an example input sample for tenant data, and FIG. 10(c) illustrates an example input sample for facility data, in accordance with an example

Example implementations regarding inventory capacity management can involve various aspects. In a first aspect, there are sub-part recommendations that suggest optimal sub-parts for efficient operations. In a second aspect, there is order planning, which assists in deciding the best times to place orders. In a third aspect, there is automated reporting that streamlines report generation for enhanced decision-making. In a fourth aspect, there is provisioning and decommissioning which facilitates the setup and retirement of resources effectively.

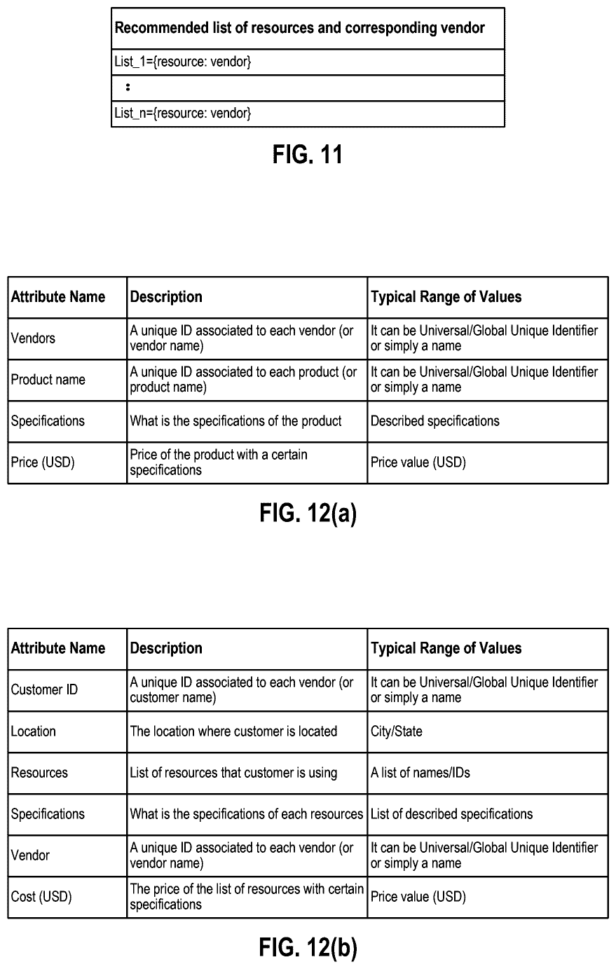

FIG. 11 illustrates an example output for the equipment and the corresponding score for a sub part recommendation, in accordance with an example implementation. This application will recommend “n” list of equipment belong to different vendors, sorted based on a score which is based on availability, price, quality, and other interesting factors for datacenter.

FIGS. 12(a) and 12(b) illustrate examples of a vendor product list hierarchy, in accordance with an example implementation. Inputs can include detailed bill of materials (BOM) along with their hierarchy, different product brands, quality/characteristics information, and so on, along with the vendor information for the BOM purchase and the SLA data.

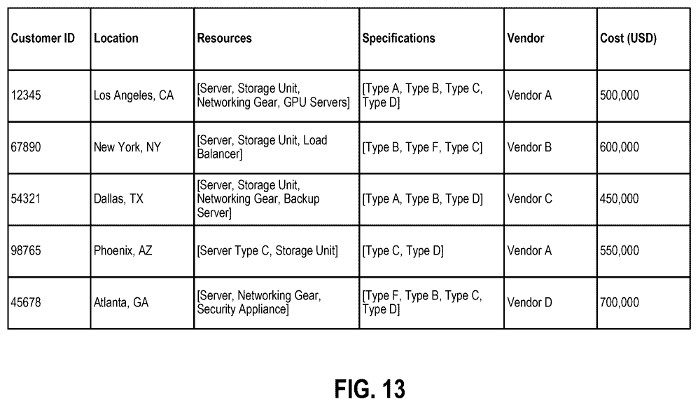

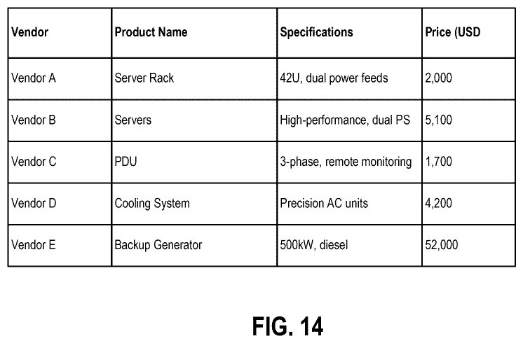

FIG. 13 illustrates an example of the tenant product list hierarchy, in accordance with an example implementation. FIG. 14 illustrates an example of the vendor product list hierarchy, in accordance with an example implementation. Specifically, FIG. 13 and FIG. 14 illustrate an example of the inputs for the vendor recommendation. The tenant product list hierarchy can include tenant identifier, location, resource, specifications, vendor, and cost. The vendor product list hierarchy can include vendor, product name, specifications, and price.

In example implementations, there is also capacity allocation and optimization for the data center. The capacity utilization KPIs and KRIs are incorporated to conduct capacity scenario simulations focusing on cost, time, and power variables for each tenant, as well as to integrate dynamic resource allocation with power forecasting.

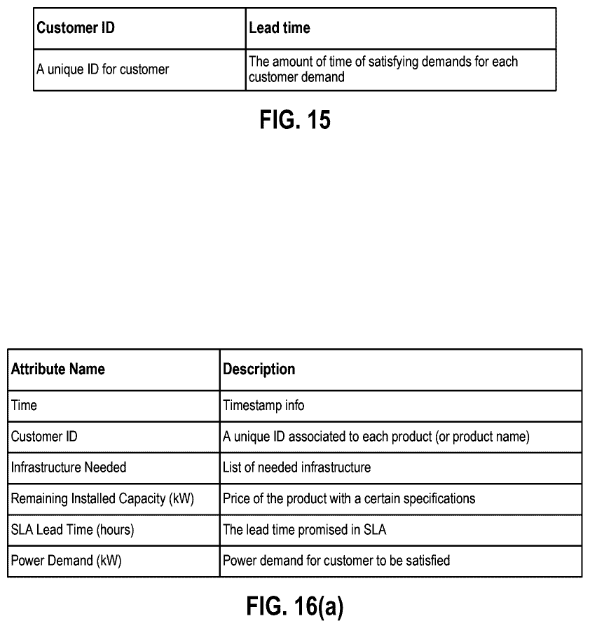

In example implementations, there is a dynamic resource allocation application which can assign the available resources to the current demand of tenants. FIG. 15 illustrates an example output of the lead time for satisfying demands for each tenant demand, in accordance with an example implementation. As shown in FIG. 15, there can be a tenant identifier as well as the lead time indicating the amount of time for satisfying the demands for each tenant demand.

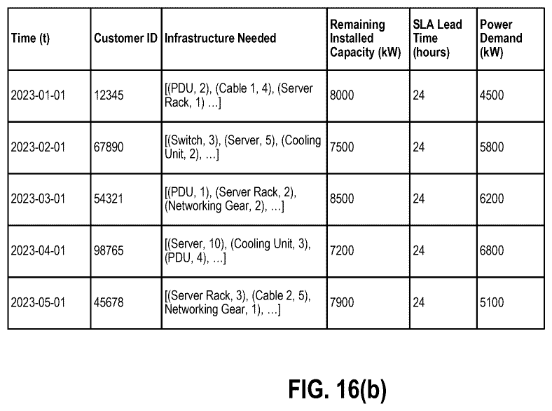

FIGS. 16(a) and 16(b) illustrate an example of the input for the dynamic resource allocation application, in accordance with an example implementation. To provide an efficient and automatic resource allocation procedure the following is used for input: list of ready orders at each time t, remained installed capacity for each tenant, SLA lead time per tenant, Power demand of tenant at each time t, and so on.

Through the dynamic resource allocation in the example implementations for colocation data centers, there can be efficient resource allocation within colocation data centers, which is paramount for meeting tenant demands while ensuring operational sustainability. Related art approaches to resource allocation often rely on historical data and user-specific information and they do it manually. While these methods have proven effective to some extent, they often lack the capability to adapt to rapidly changing external factors and may result in suboptimal resource utilization.

Further, colocation data centers have uncertainty in onboarding new tenants/meet the current tenants need on-time. It is hard to accurately predict the rack, tenants, and facility power usage/ahead of time to preorder the resources that might have a high risk to get prepared in the predefined time interval.

In addition, the example implementations can notify tenants in the case of violation of their SLA or the risk of depletion of their current capacity so that they can plan for extension, and also providing useful KPIs for tenants and datacenters to get an idea of their usage in hierarchical levels (per rack, per tenant, per facility).

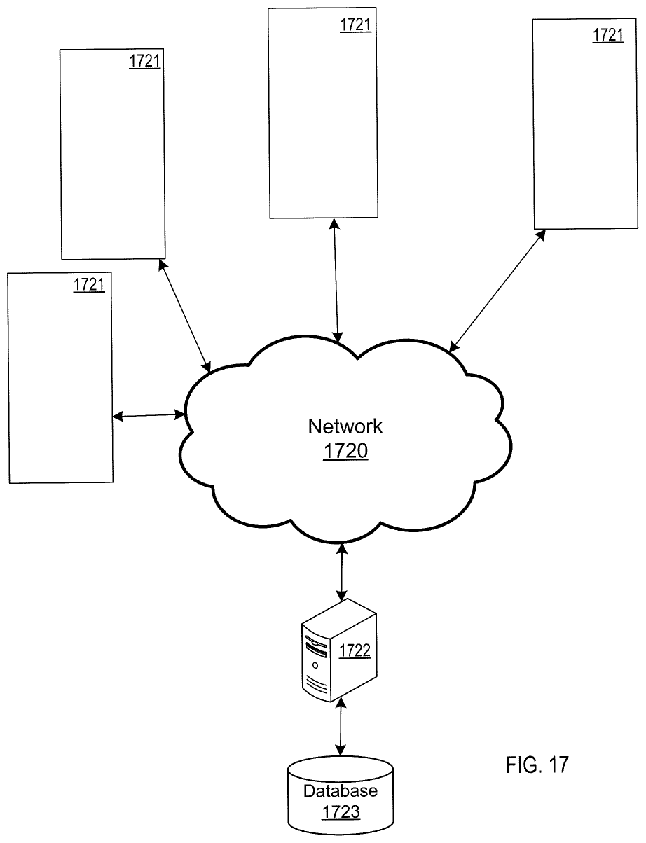

FIG. 17 illustrates a plurality of tenants that are networked to a management apparatus in a colocation data center, in accordance with an example implementation. One or more tenants 1721 involve physical machines and equipment (e.g., server racks, switches/routers, storage systems, etc.) that are communicatively coupled to a network 1720 (e.g., local area network (LAN), wide area network (WAN)) through the corresponding network interface of the sensor system installed in the physical systems 1721, which is connected to a management apparatus 1722 configured to facilitate the functionality for conducting operations for the tenant. The one or more systems 1721 may or may not be associated with sensors or other data collecting mechanisms, depending on the desired implementation. The management apparatus 1722 manages a database 1723, which contains historical data collected from the sensor systems or data collecting mechanisms from each of the physical systems 1721. In alternate example implementations, the data from the sensor systems of the physical systems 1721 can be stored in a central repository or central database such as proprietary databases that intake data from the physical systems 1721, or systems such as enterprise resource planning systems, and the management apparatus 1722 can access or retrieve the data from the central repository or central database. The sensor systems of the physical systems 1721 can include any type of sensors to facilitate the desired implementation and provide internal status machine data, such as but not limited to gyroscopes, accelerometers, global positioning satellite (GPS), thermometers, humidity gauges, or any sensors, and so on. As described herein, the management apparatus 1722 can also be connected to one or more cameras (not illustrated) that are monitoring the external status of the machines of the one or more physical systems 1721.

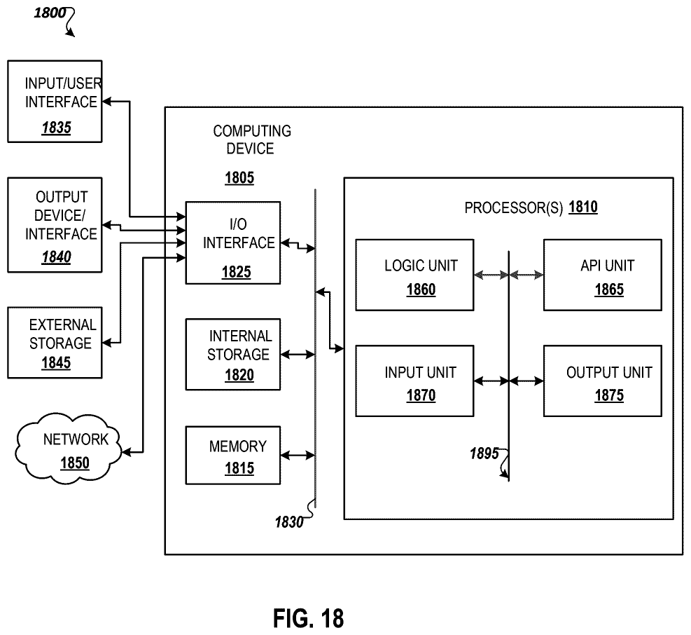

FIG. 18 illustrates an example computing environment with an example computer device suitable for use in some example implementations, such as the management apparatus 1722 to facilitate the functionality of each tenant. Computer device 1805 in computing environment 1800 can include one or more processing units, cores, or processors 1810, memory 1815 (e.g., RAM, ROM, and/or the like), internal storage 1820 (e.g., magnetic, optical, solid state storage, and/or organic), and/or I/O interface 1825, any of which can be coupled on a communication mechanism or bus 1830 for communicating information or embedded in the computer device 1805. I/O interface 1825 is also configured to receive images from cameras or provide images to projectors or displays, depending on the desired implementation.

Computer device 1805 can be communicatively coupled to input/user interface 1835 and output device/interface 1840. Either one or both of input/user interface 1835 and output device/interface 1840 can be a wired or wireless interface and can be detachable. Input/user interface 1835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1840 may include a display, television, monitor, printer, speaker, braille, or the like. In some example implementations, input/user interface 1835 and output device/interface 1840 can be embedded with or physically coupled to the computer device 1805. In other example implementations, other computer devices may function as or provide the functions of input/user interface 1835 and output device/interface 1840 for a computer device 1805.

Examples of computer device 1805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1805 can be communicatively coupled (e.g., via I/O interface 1825) to external storage 1845 and network 1850 for communicating with any number of networked components, devices, and systems, including one or more computer devices of the same or different configuration. Computer device 1805 or any connected computer device can be functioning as, providing services of, or referred to as a server, client, thin server, general machine, special-purpose machine, or another label.

I/O interface 1825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1800. Network 1850 can be any network or combination of networks (e.g., the Internet, local area network, wide area network, a telephonic network, a cellular network, satellite network, and the like).

Computer device 1805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1810 can execute under any operating system (OS) (not shown), in a native or virtual environment. One or more applications can be deployed that include logic unit 1860, application programming interface (API) unit 1865, input unit 1870, output unit 1875, and inter-unit communication mechanism 1895 for the different units to communicate with each other, with the OS, and with other applications (not shown). The described units and elements can be varied in design, function, configuration, or implementation and are not limited to the descriptions provided. Processor(s) 1810 can be in the form of hardware processors such as central processing units (CPUs) or in a combination of hardware and software units.

In some example implementations, when information or an execution instruction is received by API unit 1865, it may be communicated to one or more other units (e.g., logic unit 1860, input unit 1870, output unit 1875). In some instances, logic unit 1860 may be configured to control the information flow among the units and direct the services provided by API unit 1865, input unit 1870, output unit 1875, in some example implementations described above. For example, the flow of one or more processes or implementations may be controlled by logic unit 1860 alone or in conjunction with API unit 1865. The input unit 1870 may be configured to obtain input for the calculations described in the example implementations, and the output unit 1875 may be configured to provide output based on the calculations described in example implementations.

Processor(s) 1810 can be configured to execute a method or instructions for resource allocation and configuration of equipment in colocation data centers (e.g., for the tenants/tenants in the colocation data centers), which can include predicting hierarchical capacity demand 112 for each of the tenants of the colocation data centers using internal demand signals (e.g., historical demand data 101, CRM data 102) and external demand signals (e.g., Macroeconomics Data 103, Market Research and Reports 104); determining remaining capacity available for the each of the tenants 110; determining additional capacity needed for the each of the tenants 114 (e.g., via survival analysis to determine capacity depletion per tenant) based on the remaining capacity available and the predicted hierarchical capacity demand of the each of the tenants; generating a recommended configuration 130 for the each of the tenants determined to require additional capacity based on a current configuration of the each of the tenants and the determined additional capacity needed, and for the recommended configuration being accepted, while the recommended configuration is being implemented, optimize allocation of resources 152 to the recommended configuration based on tenant priority score function 155, current allocation, and remaining capacity; and controlling the colocation data centers to allocate the resources according to the optimization. The control of the colocation data center can be conducted in accordance with the desired implementation (e.g., management server controlling the allocation of the resources).

Processor(s) 1810 can be configured to execute the method or instructions described above, and further involve monitoring capacity usage (e.g., SLA violation, risk factors) of the tenants of the colocation data centers.

Processor(s) 1810 can be configured to execute the method or instructions described above, and further involve providing a lead time to implement the recommended configuration as described herein.

Processor(s) 1810 can be configured to execute the method or instructions described above, wherein the predicting the hierarchical capacity demand is based on similarity of historical demand pattern of tenants across the colocation data centers or within the colocation data centers as described herein.

Processor(s) 1810 can be configured to execute the method or instructions described above, wherein the method for the resource allocation and the configuration of colocation data centers is executed in response to a detection of a service level agreement (SLA) violation.

Processor(s) 1810 can be configured to execute the method or instructions described above, wherein the method for the resource allocation and the configuration of the colocation data centers is executed in response to a capacity depletion/survival analysis process providing a probability prediction of capacity depletion beyond a threshold.

Processor(s) 1810 can be configured to execute the method or instructions described above, wherein the prediction of hierarchical capacity demand is further based on received macroeconomic data, and for when the received macroeconomic data changes beyond a threshold, the prediction of the hierarchical capacity demand is re-executed.

Processor(s) 1810 can be configured to execute the method or instructions described above, and further involve providing key performance indicator and key risk indicators to the each of the tenants. Depending on the desired implementation, the key risk indicators can be derived from data mining of a service level agreement for the each of the tenants.

Processor(s) 1810 can be configured to execute the method or instructions described above, wherein generating the recommended configuration is based on equipment similarity across vendors to a current configuration as derived across the colocation data centers.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for resource allocation and configuration of equipment in colocation data centers, comprising:
predicting hierarchical capacity demand for each of the tenants of the colocation data centers using internal demand signals and external demand signals;
determining remaining capacity available for the each of the tenants;
determining additional capacity needed for the each of the tenants based on the remaining capacity available and the predicted hierarchical capacity demand of the each of the tenants;
generating a recommended configuration for the each of the tenants determined to require additional capacity based on a current configuration of the each of the tenants and the determined additional capacity needed;
for the recommended configuration being accepted:
while the recommended configuration is being implemented, optimize allocation of resources to the recommended configuration based on tenant priority score function, current allocation, and remaining capacity; and
controlling the colocation data centers to allocate the resources according to the optimization.

2. The method of claim 1, further comprising monitoring capacity usage of the tenants of the colocation data centers.

3. The method of claim 1, further comprising providing a lead time to implement the recommended configuration.

4. The method of claim 1, wherein the predicting the hierarchical capacity demand is based on similarity of historical demand pattern of tenants across the colocation data centers or within the colocation data centers.

5. The method of claim 1, wherein the method for the resource allocation and the configuration of colocation data centers is executed in response to a detection of a service level agreement (SLA) violation.

6. The method of claim 1, wherein the method for the resource allocation and the configuration of the colocation data centers is executed in response to a capacity depletion analysis process providing a probability prediction of capacity depletion beyond a threshold.

7. The method of claim 1, wherein the prediction of hierarchical capacity demand is further based on received macroeconomic data, and for when the received macroeconomic data changes beyond a threshold, the prediction of the hierarchical capacity demand is re-executed.

8. The method of claim 1, further comprising providing key performance indicator and key risk indicators to the each of the tenants.

9. The method of claim 8, wherein the key risk indicators are derived from data mining of a service level agreement for the each of the tenants.

10. The method of claim 1, wherein generating the recommended configuration is based on equipment similarity across vendors to a current configuration as derived across the colocation data centers.

11. A non-transitory computer readable medium, storing instructions for resource allocation and configuration of equipment in colocation data centers, the instructions comprising:
predicting hierarchical capacity demand for each of the tenants of the colocation data centers using internal demand signals and external demand signals;
determining remaining capacity available for the each of the tenants;
determining additional capacity needed for the each of the tenants based on the remaining capacity available and the predicted hierarchical capacity demand of the each of the tenants;
generating a recommended configuration for the each of the tenants determined to require additional capacity based on a current configuration of the each of the tenants and the determined additional capacity needed;
for the recommended configuration being accepted:
while the recommended configuration is being implemented, optimize allocation of resources to the recommended configuration based on tenant priority score function, current allocation, and remaining capacity; and
controlling the colocation data centers to allocate the resources according to the optimization.

12. The non-transitory computer readable medium of claim 11, further comprising monitoring capacity usage of the tenants of the colocation data centers.

13. The non-transitory computer readable medium of claim 11, further comprising providing a lead time to implement the recommended configuration.

14. The non-transitory computer readable medium of claim 11, wherein the predicting the hierarchical capacity demand is based on similarity of historical demand pattern of tenants across the colocation data centers or within the colocation data centers.

15. The non-transitory computer readable medium of claim 11, wherein the method for the resource allocation and the configuration of colocation data centers is executed in response to a detection of a service level agreement (SLA) violation.

16. The non-transitory computer readable medium of claim 11, wherein the method for the resource allocation and the configuration of the colocation data centers is executed in response to a capacity depletion analysis process providing a probability prediction of capacity depletion beyond a threshold.

17. The non-transitory computer readable medium of claim 11, wherein the prediction of hierarchical capacity demand is further based on received macroeconomic data, and for when the received macroeconomic data changes beyond a threshold, the prediction of the hierarchical capacity demand is re-executed.

18. The non-transitory computer readable medium of claim 11, further comprising providing key performance indicator and key risk indicators to the each of the tenants.

19. The non-transitory computer readable medium of claim 18, wherein the key risk indicators are derived from data mining of a service level agreement for the each of the tenants.

20. The non-transitory computer readable medium of claim 11, wherein generating the recommended configuration is based on equipment similarity across vendors to a current configuration as derived across the colocation data centers.
